(19) United States
(12) Patent Application Publication
(10) Pub. No.: US 2017/0274345 A1
(43) Pub. Date: Sep. 28, 2017

(54) PHOTOCATALYTIC REACTORS AND RELATED METHODS

(71) Applicant: SABIC Global Technologies B.V., Amsterdam (NL)

(72) Inventors: Habib Katsiev, Thuwal (SA); Albraa Jaber, Thuwal (SA); Yahya Al Salik, Thuwal (SA); Hicham Idriss, Thuwal (SA)

(21) Appl. No.: 15/509,996

(22) PCT Filed: Sep. 24, 2015
(86) PCT No.: PCT/IB2015/002020

§ 371 Date: Mar. 9, 2017

Related U.S. Application Data
(60) Provisional application No. 62/058,904, filed on Oct. 2, 2014.

(51) Int. Cl. B01J 19/12; C01B 3/02; C01B 3/22; C01B 3/04

(52) U.S. Cl. CPC B01J 19/123; C01B 3/04; C01B 3/02; C01B 3/22; B01J 2219/1923; B01J 2219/0892; Y02E 60/364

(57) ABSTRACT

Some of the present reactors and systems include a reactor body having a substantially-planar bottom and one or more sidewalls extending from the bottom to define a recess, the reactor body defining inlet(s) and outlet(s) for liquid and gas, and a lid configured to be coupled to the reactor body to cover the recess such that the interface between the reactor body and the lid is substantially sealed, where at least one of the reactor body and the lid is configured to transmit incident ultraviolet light into the recess, and where the reactor body is configured to receive a photocatalyst in the recess such that at least a portion of liquid delivered to the recess through the liquid inlet(s) can react with the photocatalyst in the presence of the ultraviolet light to generate gas. Some reactors and systems include liquid and gas circulation systems having pumps and conduits.

### RELATED APPLICATIONS

This application claims benefit to U.S. Provisional Patent Application No. 62/058,904 filed Oct. 2, 2014 titled “PHOTOCATALYTIC REACTORS AND RELATED METHODS”. The entire contents of the referenced application are incorporated herein by reference.

### BACKGROUND

1. Field of Invention

The present invention relates generally to reactors, and more specifically, but not by way of limitation, to photocatalytic reactors, such as, for example, for producing hydrogen from liquids, such as water, sacrificial agents, organic compounds, particulate matter, mixtures thereof, and/or the like.

2. Description of Related Art

Light from the sun, while being the most abundant source of energy on earth, contributes less than approximately 0.05% of the total power used by humans (only accounting for approximately 15,000 Gigawatts (GW) per year, excluding solar heating). However, solar energy can be harnessed, for example, with semiconductor photocatalysts to generate energy carriers (e.g., hydrogen) from renewable sources (e.g., water, ethanol, and the like). Examples of photocatalytic reactors are disclosed in Chinese Patent No. 102151534, Japanese Patent No. 2013234077, U.S. Pat. No. 7,909,979, and U.S. Pub No. 2011/0203661.

### SUMMARY

Some embodiments of the present reactors are configured, through a recess defined by sidewalls of a reactor body, to expose a liquid (e.g., a reactant, such as, for example water, with or without a sacrificial agent) to a photocatalyst (e.g., which can include a thin layer disposed within the recess, suspended particles within the liquid (e.g., in a slurry), and/or an aerogel, which may be disposed in and/or on the liquid). Some embodiments are configured, through the recess, such that the liquid is in direct contact with the photocatalyst when the liquid reacts with the photocatalyst to produce gas. Some embodiments are configured, through an adjustable stand coupled to the reactor, to be adjustable in orientation (e.g., relative to a light source, such as the sun) (e.g., to maximize light absorption by a photocatalyst within the recess).

Some embodiments of the present photocatalytic reactors include a reactor body that includes a substantially-planar bottom and one or more sidewalls extending from the bottom to define a recess, the reactor body defining: at least one liquid inlet, at least one liquid outlet, at least one gas inlet, and at least one gas outlet, such that each of the inlets and outlets of the reactor body are in fluid communication with the recess; and a lid configured to be coupled to the reactor body to cover the recess such that the interface between the reactor body and the lid is substantially sealed; where at least one of the reactor body and the lid is configured to transmit incident ultraviolet light into the recess; and where the reactor body is configured to receive a photocatalyst in the recess such that at least a portion of liquid delivered to the recess through the at least one liquid inlet can react with the photocatalyst in the presence of the ultraviolet light to generate gas. In some embodiments, the recess of the reactor body has a maximum height and a maximum transverse dimension that is greater than the maximum height. In some embodiments, the maximum transverse dimension is at least 5 times greater than the maximum height. In some embodiments, the recess is configured such that the liquid directly contacts the photocatalyst when the liquid reacts with the photocatalyst in the presence of the ultraviolet light to generate gas. Some embodiments can further include a photocatalyst that includes an aerogel layer disposed on an interior surface of at least one of the lid and the reactor body. In some embodiments, the recess has a quadrilateral shape, a rectangular shape, or a square shape.

Some embodiments of the present photocatalytic reactor systems include an embodiment of the present reactors; a liquid delivery system that can include a pump, a first conduit configured to be coupled to an outlet of the pump and the at least one liquid inlet of the reactor body, and a second conduit configured to be coupled to an inlet of the pump and the at least one liquid outlet of the reactor body; and a gas circulation system that can include a pump, a first conduit configured to be coupled to an outlet of the pump and the at least one gas inlet of the reactor body, and a second conduit configured to be coupled to an inlet of the pump and the at least one gas outlet of the reactor body; where at least one of the reactor body and the lid is configured to transmit incident ultraviolet light into the recess; and where the reactor body is configured to receive a photocatalyst in the recess such that reaction of at least a portion of the liquid with the photocatalyst in the presence of the ultraviolet light can generate gas.

In some embodiments of the present systems, the gas circulation system can include a valve coupled to at least one of the first and second conduits and configured to selectively interrupt the flow of gas through the at least one of the first and second conduits. In some embodiments, the valve is configured to selectively direct gas to a gas chromatograph.

In some embodiments of the present systems, the recess is configured such that the at least a portion of the liquid is in direct contact with the photocatalyst when the liquid reacts with the photocatalyst in the presence of the ultraviolet light to generate gas.

In some embodiments of the present systems, the liquid delivery system is configured to continuously circulate liquid through the recess via the at least one liquid inlet and the at least one liquid outlet.

In some embodiments of the present systems, the liquid delivery system is configured to fill a majority of the recess with liquid.

Some embodiments of the present systems can further include a photocatalyst disposed on an interior surface of at least one of the lid and the reactor body. In some embodiments, the photocatalyst can include an aerogel layer. In some embodiments, the photocatalyst can include a film coating. In some embodiments, the photocatalyst can include an electroconductive material and a metal oxide.

In some embodiments of the present systems, a liquid is disposed in the liquid delivery system and the liquid can include a reactant and a sacrificial agent. In some embodiments, the reactant can include water.

In some embodiments of the present systems, the reactor is configured to be positioned at an angle relative to a surface above which the reactor is supported. Some embodiments can further include a stand configured to support the reactor body above a surface in at least a first position in which the reactor body is substantially level, and a second position in which the reactor body is angled relative to the surface.

Some embodiments of the present systems can further include a gasket configured to be disposed between the lid and the one or more sidewalls of the reactor body to seal the interface between the reactor body and the lid. In some embodiments, at least one of the reactor body and the lid defines a groove configured to receive the gasket.

In some embodiments of the present systems, at least one of the reactor body and the lid can include one or more polymers. In some embodiments, the one or more polymers can include a thermoplastic polymer. In some embodiments, the one or more polymers can include at least one of: acrylates, polyacrylates, polymethacrylates, polyvinyl alcohols, polyolefins, and/or mixtures thereof. In some embodiments, at least one of the reactor body and the lid can include a transparent material. In some embodiments, the transparent material can include at least one of: silica, polymeric material, quartz, borosilicate, acrylate polymers, copolymers, polymethylmethacrylate, polycarbonate, and/or mixtures thereof.

In some embodiments of the present systems, a liquid is disposed in the recess; and a photocatalyst suspended in and/or on the liquid.

Some embodiments of the present systems can further include a light source configured to deliver light to the reactor. In some embodiments, the light source is configured to deliver ultraviolet light.

Some embodiments of the present methods (e.g., production of hydrogen gas (H₂)) use an embodiment of the present reactors, and can include delivering a liquid to the recess through the liquid inlet of the reactor body such that the liquid contacts a photocatalyst in the recess in the presence of ultraviolet light to produce gas; and removing at least a portion of the produced gas from the recess through the gas outlet of the reactor as a gas stream; where the lid is coupled to the reactor body such that the lid covers the recess and the interface between the reactor body and the lid is substantially sealed; and where at least a portion of the gas stream can include H₂. In some embodiments, the photocatalyst is disposed on an interior surface of at least one of the lid and the reactor body. In some embodiments, the photocatalyst can include a film coating. In some embodiments, the photocatalyst can include an aerogel layer. In some embodiments, the photocatalyst is suspended in and/or on the liquid. In some embodiments, the liquid can include water and a sacrificial agent. In some embodiments, the contacting can include continuously circulating the liquid through the reactor. Some embodiments can include delivering the liquid to the recess such that the liquid reaches a desired depth in the recess. Some embodiments can include analyzing a portion of the gas stream to determine an amount of the H₂. Some embodiments can include circulating the gas stream through the at least one gas inlet and the at least one gas outlet until an amount of H₂ reaches a predetermined threshold.

In the context of the present invention forty (40) embodiments are described. Embodiment 1 is a photocatalytic reactor that includes a reactor body that includes a substantially-planar bottom and one or more sidewalls extending from the bottom to define a recess, the reactor body defining: at least one liquid inlet, at least one liquid outlet, at least one gas inlet, and at least one gas outlet, such that each of the inlets and outlets of the reactor body are in fluid communication with the recess; and a lid configured to be coupled to the reactor body to cover the recess such that the interface between the reactor body and the lid is substantially sealed; wherein at least one of the reactor body and the lid is configured to transmit incident ultraviolet light into the recess, and wherein the reactor body is configured to receive a photocatalyst in the recess such that at least a portion of liquid delivered to the recess through the at least one liquid inlet can react with the photocatalyst in the presence of the ultraviolet light to generate gas. Embodiment 2 is the reactor of embodiment 1, wherein the recess of the reactor body has a maximum height and a maximum transverse dimension that is greater than the maximum height. Embodiment 3 is the reactor of embodiment 2, wherein the maximum transverse dimension is at least 5 times greater than the maximum height. Embodiment 4 is the reactor of embodiment 1, wherein the recess is configured such that the liquid is in direct contact with the photocatalyst when the liquid reacts with the photocatalyst in the presence of the ultraviolet light to generate gas. Embodiment 5 is the reactor of embodiment 1 that includes a photocatalyst that includes an aerogel layer disposed on an interior surface of at least one of the lid and the reactor body.

Embodiment 6 is a photocatalytic reactor system that include a reactor of any one of embodiments 1 to 5; a liquid delivery system that includes a pump, a first conduit configured to be coupled to an outlet of the pump and the at least one liquid inlet of the reactor body, and a second conduit configured to be coupled to an inlet of the pump and the at least one liquid outlet of the reactor body; and a gas circulation system that includes a pump, a first conduit configured to be coupled to an outlet of the pump and the at least one gas inlet of the reactor body, and a second conduit configured to be coupled to an inlet of the pump and the at least one gas outlet of the reactor body; wherein at least one of the reactor body and the lid is configured to transmit incident ultraviolet light into the recess; and wherein the reactor body is configured to receive a photocatalyst in the recess such that reaction of at least a portion of the liquid with the photocatalyst in the presence of the ultraviolet light can generate gas. Embodiment 7 is the system of embodiment 6, wherein the gas circulation system includes a valve coupled to at least one of the first and second conduits and configured to selectively interrupt the flow of gas through the at least one of the first and second conduits. Embodiment 8 is the system of embodiment 7, wherein the valve is configured to selectively direct gas to a gas chromatograph. Embodiment 9 is the system of embodiment 6, wherein the recess is configured such that the at least a portion of the liquid directly contacts the photocatalyst when the liquid reacts with the photocatalyst in the presence of the ultraviolet light to generate gas. Embodiment 10 is the system of any one of embodiments 6 to 9, wherein the liquid delivery system is configured to continuously circulate liquid through the recess via the at least one liquid inlet and the at least one liquid outlet. Embodiment 11 is the system of any of embodiments 6 to 9, wherein the liquid delivery system is configured to fill a majority of the recess with liquid. Embodiment 12 is the system of any one of embodiments 6 to 9, wherein a photocatalyst is disposed on an interior surface of at least one of the lid and the reactor body. Embodiment 13 is the system of embodiment 12, wherein the photocatalyst includes an aerogel layer. Embodiment 14 is the system of embodiment 12, wherein the photocatalyst includes a film coating. Embodiment 15 is the system of embodiment 12, wherein the photocatalyst includes an electroconductive material and a metal oxide. Embodiment 16 is the system of any one of embodiments 6 to 9, wherein a liquid is disposed in the liquid delivery system and the liquid includes a reactant and a sacrificial agent. Embodiment 17 is the system of embodiment 16, wherein the reactant includes water. Embodiment 18 is the system of any one of embodiments 6 to 9, wherein the reactor is configured to be positioned at an angle relative to a surface above which the reactor is supported. Embodiment 19 is the system of embodiment 18, further including a stand configured to support the reactor body above a surface in at least a first position in which the reactor body is substantially level, and a second position in which the reactor body is angled relative to the surface. Embodiment 20 is the system of any one of embodiments 6 to 9, further including a gasket configured to be disposed between the lid and the one or more sidewalls of the reactor body to seal the interface between the reactor body and the lid. Embodiment 21 is the system of embodiment 20, wherein at least one of the reactor body and the lid defines a groove configured to receive the gasket. Embodiment 22 is the system of any one of embodiments 6 to 9, wherein at least one of the reactor body and the lid includes one or more polymers. Embodiment 23 is the system of embodiment 22, wherein the one or more polymers includes a thermoplastic polymer. Embodiment 24 is the system of embodiment 22, wherein the one or more polymers includes at least one of: acrylates, polyacrylates, polymethacrylates, polyvinyl alcohols, polyolefins, and mixtures thereof. Embodiment 25 is the system of any one of embodiments 6 to 9, wherein at least one of the reactor body and the lid includes a transparent material. Embodiment 26 is the system of embodiment 25, wherein the transparent material includes at least one of: silica, polymeric material, quartz, borosilicate, acrylate polymers, copolymers, polymethylmethacrylate, polycarbonate, and mixtures thereof. Embodiment 27 is the system of any one of embodiments 6 to 9, wherein the recess has a quadrilateral shape, a rectangular shape, or a square shape. Embodiment 28 is the system of any one of embodiment 6-9, wherein liquid is disposed in the recess; and a photocatalyst is suspended in and/or on the liquid. Embodiment 29 is the system of any one of embodiments 6 to 9, further including a light source configured to deliver light to the reactor. Embodiment 30 is the system of embodiment 29, wherein the light source is configured to deliver ultraviolet light.

Embodiment 31 is a method of producing hydrogen gas (H2) using a reactor of any one of embodiments 1 to 5 that includes delivering a liquid to the recess through the liquid inlet of the reactor body such that the liquid contacts a photocatalyst in the recess in the presence of ultraviolet light to produce gas; and removing at least a portion of the produced gas from the recess through the gas outlet of the reactor as a gas stream; wherein the lid is coupled to the reactor body such that the lid covers the recess and the interface between the reactor body and the lid is substantially sealed, and wherein at least a portion of the gas stream includes H₂. Embodiment 32 is the method of embodiment 31, wherein the photocatalyst is disposed on an interior surface of at least one of the lid and the reactor body. Embodiment 33 is the method of embodiment 32, wherein the photocatalyst includes a film coating. Embodiment 34 is the method of embodiment 31, wherein the photocatalyst includes an aerogel layer. Embodiment 35 is the method of embodiment 31, wherein the photocatalyst is suspended in and/or on the liquid. Embodiment 36 is the method of embodiment 31, wherein the liquid includes water and a sacrificial agent. Embodiment 37 is the method of embodiment 31, wherein contacting includes continuously circulating the liquid through the reactor. Embodiment 38 is the method of embodiment 31, further including delivering the liquid to the recess such that the liquid reaches a desired depth in the recess. Embodiment 39 is the method of embodiment 31, further including analyzing a portion of the gas stream to determine an amount of the H₂. Embodiment 40 is the method of embodiment 31, further including circulating the gas stream through the at least one gas inlet and the at least one gas outlet until an amount of H₂ reaches a predetermined threshold.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, 10, and 20 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The apparatus, systems and methods of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the apparatus of the present invention is the use of the apparatus to generate hydrogen gas from water.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1A is a perspective view of one embodiment of the present reactors.

FIG. 1B-1C are top and perspective views, respectively, of the reactor of FIG. 1A.

FIG. 1D is a perspective view of the reactor of FIG. 1A, showing a removable lid.

FIG. 2A and 2B are perspective and cutaway perspective views, respectively, of the reactor of FIG. 1A showing an adjustable stand.

FIG. 3A is a perspective view of one embodiment of the present systems.

FIG. 3B is a top view of the system of FIG. 3A.

### DETAILED DESCRIPTION OF ILLUSTRATIVE EMBODIMENTS

Photocatalytic reactors can be suitable for a variety of purposes (e.g., with applications ranging from environmental clean up to hydrogen production) [7-14].

The photo-assisted dissociation (e.g., splitting) of water into hydrogen and oxygen can be achieved with external bias and without the need for such an external bias. Currently, however, only relatively low hydrogen evolution rates have been achieved. Additionally, in systems employing wide-bandgap semiconductor photocatalysts (e.g., TiO₂ and other related materials), ultraviolet light (e.g., with an energy greater than 3 electron volts (eV)) may be needed to excite photocatalytic reactions, and this need may pose issues for practical applications. Attempts to improve the photocatalytic reaction include the use of modified photocatalysts which, unlike pure TiO₂, respond to visible light (e.g., sunlight), but have met with relatively limited success.

Conventional reactors can be configured for photocatalysts in a variety of configurations, such as, for example, a thin layer coated on an interior surface of the reactor, suspended particles (e.g., within and/or including a liquid, such as forming part of a slurry), aerogels (e.g., within a liquid and/or floating on a liquid interface), and/or the like. As used in this disclosure, liquid includes, but is not limited to, water, sacrificial agents, organic compounds, particulate matter, slurries, mixtures thereof, and/or the like.

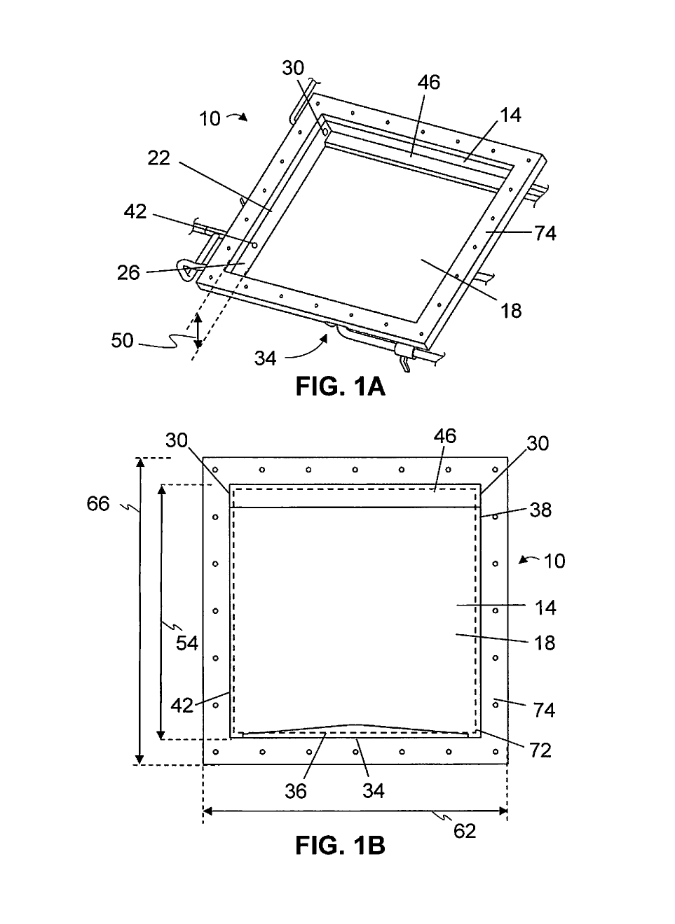

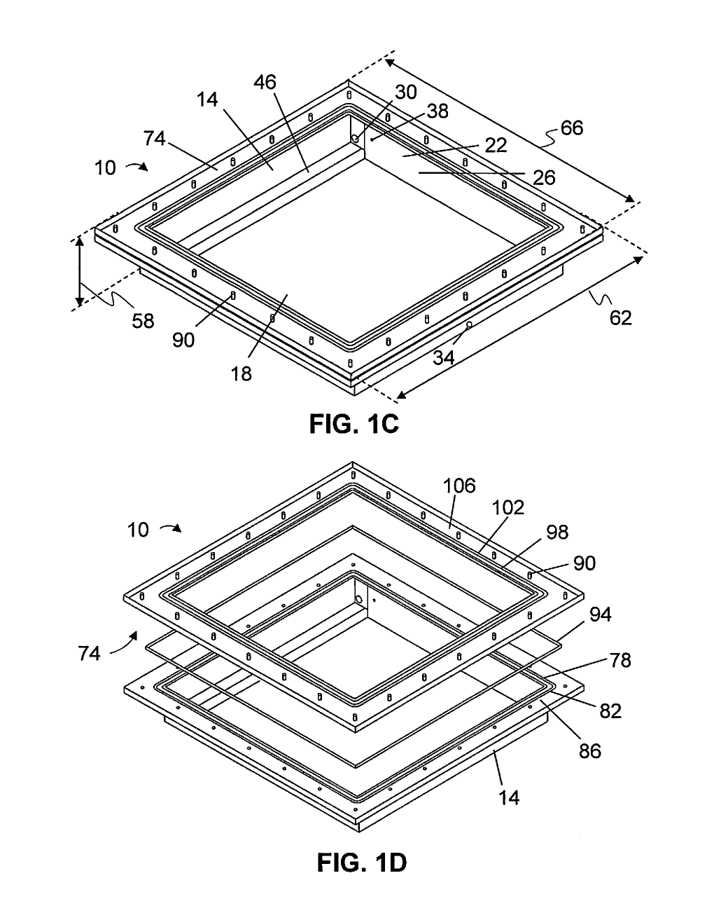

Referring now to the drawings, and more particularly to FIGS. 1A-1D, shown therein and designated by the reference numeral 10 is one embodiment of the present reactors. In the embodiment shown, reactor 10 includes a reactor body 14 having a substantially-planar bottom 18 and one or more sidewalls 22 that extend from the bottom to define a recess 26.

In this embodiment, reactor body 14 defines at least one liquid inlet (e.g., opening) 30 (e.g., two (2) liquid inlets), and at least one liquid outlet (e.g., opening) 34 (e.g., one (1) liquid outlet). In the embodiment shown, liquid outlet 34 is defined within or adjacent to (e.g., by a sidewall 22 adjacent to) a depression 36 defined by bottom 18, which can encourage liquid flow through liquid outlet 34. In the depicted embodiment, liquid outlet 34 has a larger cross-sectional flow area than liquid inlets 30 (e.g., to maintain a mass flow rate of liquid through reactor 10, if desired). As shown, the liquid inlet(s) are defined on an opposite side of reactor body 14 from the liquid outlet(s) (e.g., the liquid inlet(s) are defined on an opposing sidewall 22 from the liquid outlet(s)). In this way, for example, flow of liquid through a majority of recess 26 can be facilitated.

In the embodiment shown, reactor body 14 defines at least one gas inlet (e.g., opening) 38 and at least one gas outlet (e.g., opening) 42. In this embodiment, the gas inlet(s) are defined on an opposite side of reactor body 14 from the gas outlet(s) (e.g., the gas inlet(s) are defined on an opposing sidewall 22 from the gas outlet(s)). In the embodiment shown, each of the gas and/or liquid inlet(s) and/or outlet(s) (e.g., 30, 34, 38, 42, and/or the like) are configured to be in fluid communication with recess 26.

As shown, reactor body 14 of reactor 10 includes a step or protrusion 46 that extends into recess 26. In this embodiment, step or protrusion 46 can function to agitate, mix, and/or accelerate gas and/or liquid flow into and/or through reactor 10 (e.g., by reducing the vertical cross-sectional (e.g., flow) area of a portion of recess 26, for example, near liquid inlet(s) 30 and/or gas inlet(s) 38), which can facilitate photocatalytic reactions within the reactor as described below.

In the embodiment shown, recess 26 of reactor body 14 has a maximum height 50 (e.g., excluding depression 36 and step or protrusion 46) and a maximum transverse dimension 54 that is greater than the maximum height. For example, in the depicted embodiment, maximum transverse dimension 54 is greater than any one of or between any two of 1.1, 1.2, 1.3, 1.4, 1.5, 2, 2.5, 3, 3.5, 4, 5, 6, 7, 8, 9, 10, or more times greater than (e.g., five (5) times greater than) maximum height 50. In the embodiment shown, reactor 10 has a height 58 of 15 centimeters (cm), a length 62 of 100 (cm), and a width 66 of 100 (cm). For example, in this embodiment, reactor 10 and/or recess 26 can include a square shape; however, in other embodiments, the reactors and/or recesses can include any suitable shape, such as, for example, rectangular, quadrilateral, and/or otherwise polygonal, circular, elliptical, and/or otherwise round.

In this embodiment, recess 26 is defined by body 14 such that if a photocatalyst is disposed within the recess and liquid is flowing through the reactor, at least a portion (up to and including all) of the liquid (e.g., remaining in a liquid state) is in direct contact with the photocatalyst. For example, in this embodiment, a single recess 26 extends the entire distance between sidewalls 22 (e.g., as a single chamber, in direct fluid communication with bottom 18, liquid inlet(s) 30 and outlets 34, and gas inlet(s) 38 and outlet(s) 42, and open to at least a majority of the interior surface of each sidewall 22). As described below, photocatalysts suitable for use in the present reactors can include a variety of materials and/or configurations. By way of example, region 72, which is a suitable location for a photocatalyst (e.g., or liquid) within reactor 10 and/or recess 26, extends completely across the recess and includes interior surfaces of bottom 18, sidewalls 22, reactor body 14, lens 94, and lid 74.

In the embodiment shown, reactor 10 includes a lid 74 (shown in transparent fashion in FIGS. 1C and 1D) configured to be coupled to reactor body 14 to cover recess 26 such that the interface between the reactor body and the lid is substantially sealed. For example, in this embodiment, reactor 10 includes a gasket 78 configured to be disposed between lid 74 and one or more sidewalls 22 of reactor body 14 to seal the interface between the rector body and the lid (e.g., in an air- and/or liquid-tight fashion). Gasket 78 can include any suitable material, such as, for example, rubber, silicone, cork, paper, metal, and/or the like.

In this embodiment, gasket 78 can be received within a groove 82 (e.g., having a 5 millimeter (mm) depth), defined by at least one of reactor body 14 and lid 74, and surrounding recess 26. For example, in this embodiment, body 14 includes a flange 86 coupled to sidewalls 22 opposite bottom 18, wherein groove 82 is defined. As shown, gasket 78 can be resealable (e.g., reusable) in order to facilitate introduction and/or removal of catalyst(s) into and/or out of reactor 10 and/or maintenance, modification, and/or the like of reactor 10 and/or associated components. In other embodiments, however, gasket 78 may not be resealable, and may instead be configured to be replaced each time lid 74 is removed from reactor body 14. In this embodiment, an air- and/or liquid-tight seal can be provided by compressing gasket 78 between reactor body 14 and lid 74, for example, by inserting fasteners through a plurality of holes 90 configured to couple the lid to the body.

Reactor bodies (e.g., 14) and/or lids (e.g., 74) of the present reactors can include any suitable material, such as, for example, one or more: polymers (e.g., thermoplastic polymers), acrylates, polyacrylates, polymethacrylates, polyvinyl alcohols, polyolefins, and/or the like.

In this embodiment, at least one of reactor body 14 and lid 74 is configured to transmit incident light (e.g., visible light, UV light, and/or the like) into recess 26. For example, reactor body 14 and/or lid 74 (e.g., lid 74, in this embodiment) can comprise a lens 94 (e.g., comprising a material that is translucent and/or transparent). For example, lens 94 can include any suitable material, such as, for example, silica, polymeric material, quartz, borosilicate, acrylate polymers (e.g., Pyrex), copolymers, polymethylmethacrylate (e.g., PMMA), polycarbonate, mixtures thereof, and/or the like.

As shown, in this embodiment, lens 94 can be coupled to lid 74 in a sealed fashion, for example, through a flange 106 having a groove 102 configured to receive a gasket 98, similarly as to described above for the sealed interface between lid 74 and reactor body 14 (e.g., such that lens 94 is sealed and/or secured between flange 106 of lid 74 and flange 86 of reactor body 14). However, in other embodiments, lens 94 can be nonremovably coupled to and/or unitary with lid 74. In this embodiment, lens 94 is not configured to substantially modify incoming light (e.g., is window-like), however, in other embodiments, lens 94 can be configured to focus, disperse, and/or otherwise modify incoming light (e.g., through concave or convex features, whether included in a conventional or Fresnel-type structure).

In this embodiment, reactor body 14 is configured to receive a photocatalyst in recess 26 such that at least a portion of liquid delivered to the recess through at least one liquid inlet 30 can react with the photocatalyst in the presence of the light (e.g., transmitted through lens 94) to generate gas. The present reactors can work with any suitable liquid, such as, for example, water, sacrificial agents, organic compounds, particulate matter, slurries, mixtures thereof, and/or the like.

Photocatalysts suitable for use in the present disclosure can include any suitable material, such as, for example metal oxides, electroconductive materials, and/or the like, and perhaps more importantly, can include any suitable structure. For example, photocatalysts can be configured as a thin layer (e.g., or aerogel) or film coated on an interior surface of the recess and/or reactor (e.g., via spray coating, drop casting, and/or the like, on, for example, an interior surface of bottom 18, lens 94, lid 74, and/or the like), suspended particles (e.g., within and/or comprising a liquid that can be communicated into recess 26, such as, for example, forming party of a slurry), aerogels (e.g., suspended within a liquid and/or on a liquid interface within recess 26), and/or the like. Particularly, photocatalysts comprising an aerogel may allow maximization of reactive surface area, and can have thicknesses tailored to harvest light with maximum efficiency.

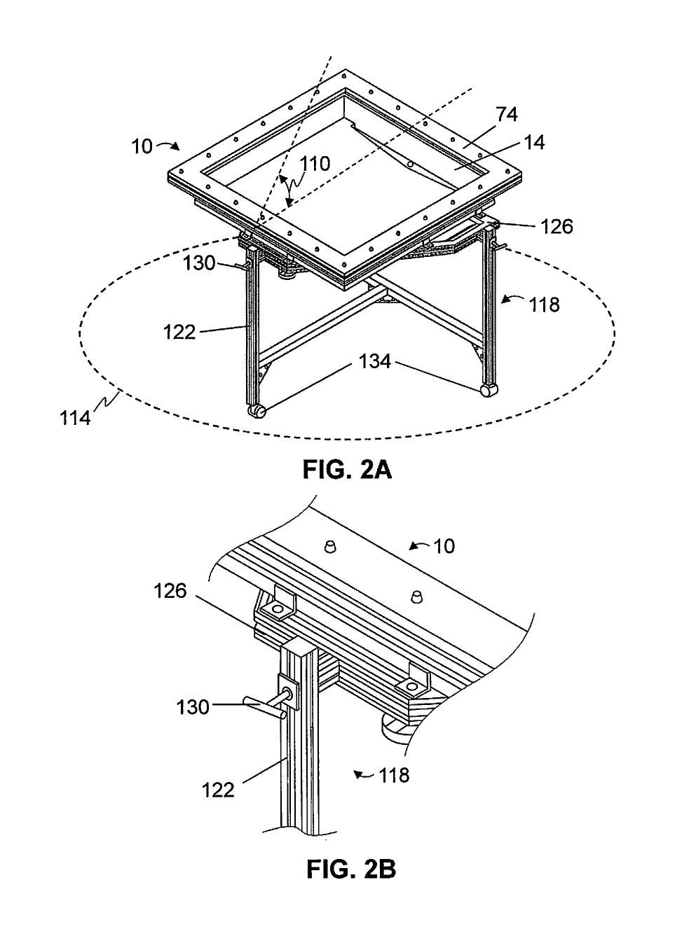

As shown in FIG. 2A and 2B, reactor 10 is configured to be positioned at an angle 110 relative to a surface 114 above which the reactor is supported. For example, in this embodiment, reactor 10 includes a stand 118 (e.g., tri-pod) configured to support reactor body 14 above surface 114 in any of at least a first position in which the reactor body is substantially level (e.g., as shown) and a second position in which the reactor body is angled relative to the surface (e.g., at an angle 110, which is greater than any one of or between any two of 1, 2, 3, 4, 5, 7.5, 10, 12.5, 15, 20, 25 degrees or larger). For example, in this embodiment, stand 118 includes a plurality of legs 122 each slidably coupled to reactor body 14 (e.g., via a support frame 126 to which reactor body 14 may be secured or otherwise supported, as shown).

In the embodiment shown, stand 118 includes a plurality of handles 130, each configured to releasably secure a portion of reactor body 14 relative to a leg 122. For example, one or more handles 130 can be actuated to allow reactor body 14 (and/or support frame 126) to slide relative to one or more legs 122 to place reactor 10 in a desired orientation (e.g., an angle 110 relative to surface 114). In this embodiment, one or more handles 130 can be actuated to releasably secure the reactor in the desired orientation. In this way, the orientation of the reactor relative to the surface can be adjusted, for example, to maximize and/or otherwise adjust the amount of light incident on recess 26 (e.g., to maximize and/or otherwise adjust photocatalytic reactions within reactor 10). Such orientation adjustments can be facilitated by the provision of a plurality of wheels 134, each coupled to a leg 122 at an end that is adjacent to surface 114.

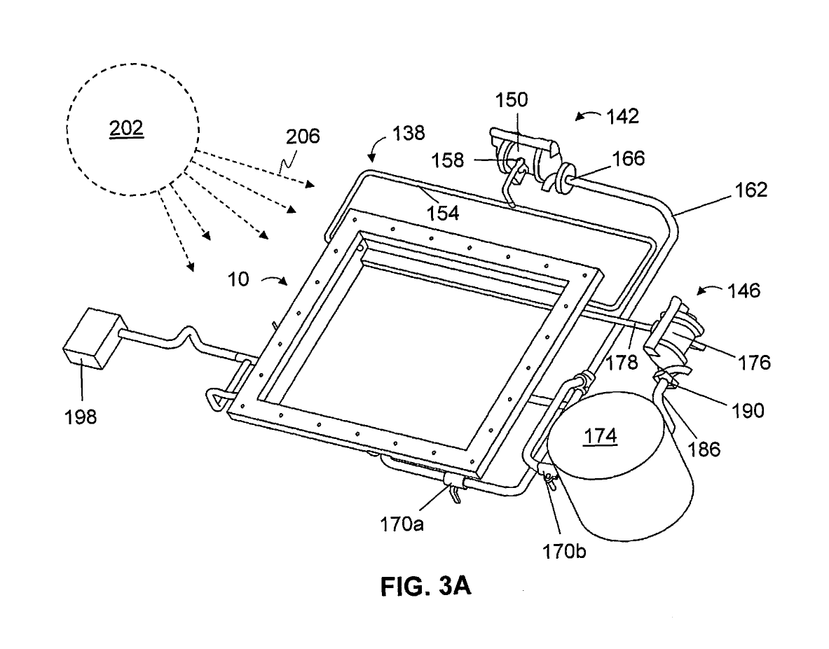

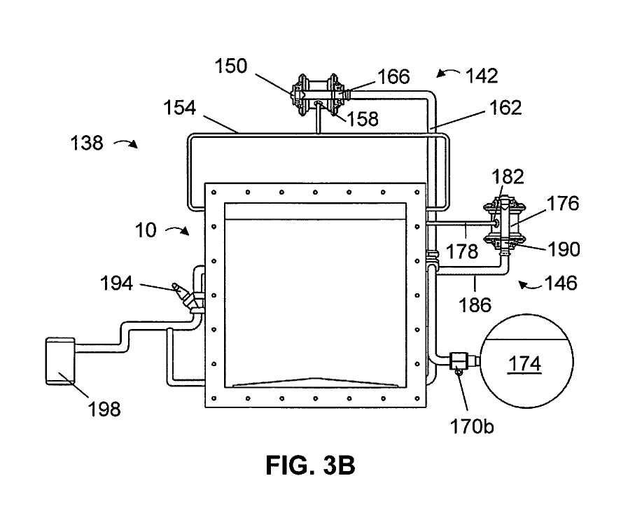

As shown in FIGS. 3A and 3B, reactor 10 can form part of a system 138. In this embodiment, system 138 includes a liquid delivery system 142 and a gas circulation system 146 (described below). Liquid delivery system 142 includes a liquid pump 150. Pumps of the present systems can include any suitable pumps, such as, for example, positive displacement pumps (e.g., diaphragm pumps, peristaltic pumps, screw pumps, and/or the like), centrifugal pumps, and/or the like. In this embodiment, liquid delivery system 142 includes a first liquid conduit 154 (e.g., tubing, piping, and/or the like) configured to be coupled to an outlet 158 of the liquid pump and at least one liquid inlet 30 of reactor body 14 (e.g., two liquid inlets 30, as shown). In this embodiment, at least a portion of the liquid delivery system forms a closed loop system. For example, as shown, liquid delivery system 142 includes a second liquid conduit 162 configured to be coupled to an inlet 166 of liquid pump and at least one liquid outlet 34 of the reactor body. In the embodiment shown, liquid delivery system 142 includes a liquid reservoir 174, which can be configured to store liquid. In this embodiment, one or more liquid valve(s) 170 can be configured to selectively activate or deactivate liquid flow into, out of, and/or through reactor 14 (e.g., via valve 170a), liquid reservoir 174 (e.g., via valve 170b), and/or the like, as well as function as a pressure relief valve (e.g., to assure safe operation of system 138).

Liquid delivery systems of the present reactors and/or systems can be configured to work in batch (e.g., a certain volume of liquid communicated into reactor 10 and/or recess 26) and/or continuous mode (e.g., continuous communication of liquid through reactor 10 and/or recess 26, for example, via continuous operation of liquid pump 150). To illustrate, in batch mode, liquid delivery system 142 can configured to fill a majority of (up to and including all of) recess 26 with liquid. For example, valve 170a can be closed to prevent liquid from leaving recess 26 through liquid outlet(s) 34, and liquid pump 150 can be operated to pump liquid into recess 26 through liquid inlet(s) 30 (e.g., and can communicate liquid to and/or from liquid reservoir 174, if desired, depending on position of valve 170b) thus filling recess 26 with liquid. Once a desired volume of liquid is within (e.g., or the liquid has reached a desired depth within) recess 26, liquid pump 150 can be deactivated. In continuous mode, liquid delivery system 142 can be configured to continuously circulate liquid through recess 26. For example, valve 170a can be opened and liquid pump 150 can be actuated to communicate liquid into recess 26 through liquid inlet(s) 30, wherein the liquid may flow out of recess 26 through liquid outlet(s) 34 and can return to the pump (e.g., through second liquid conduit 162).

In the embodiment shown, gas circulation system 146 of system 138 includes a gas pump 176, a first gas conduit 178 configured to be coupled to an outlet 182 of the pump and at least one gas inlet 38 of reactor body 14. In this embodiment, gas circulation system 146 includes a second gas conduit 186 configured to be coupled to an inlet 190 of gas pump 176 and at least one gas outlet 42 of reactor body 14. In the embodiment shown, gas circulation system 146 includes one or more gas valves 194, which can be configured to selectively activate or deactivate gas flow into, out of, and/or through reactor 14, and/or the like, as well as function as a pressure relief valve (e.g., to assure safe operation of system 138).

For example, a gas valve 194 can be configured to selectively direct gas to a gas chromatograph 198. To illustrate, when valve 194 is in a first (e.g., opened) position, a gas stream can be continuously recirculated by gas pump 176 (e.g., through recess 26), and when valve 194 is in a second (e.g., closed) position, a volume of gas can be sent to gas chromatograph 198 (e.g., for analysis). Gas chromatograph 198 can be configured to determine an amount of gas (e.g., H₂) generated (e.g., whether the amount has reached a desired threshold).

In the embodiment shown, system 10 includes a light source 202 configured to deliver light (e.g., 206) (e.g., visible light, UV light, and/or the like). Light source 202 can include any suitable light source, such as, for example, the sun, a lamp, a radiation source, and/or the like.

Some embodiments of the present methods for producing hydrogen gas (H₂) using a reactor of the present disclosure (e.g., 10) include delivering a liquid to the recess (e.g., 26) through the liquid inlet (e.g., 30) of the reactor body (e.g., 14) such that the liquid contacts a photocatalyst in the recess in the presence of ultraviolet light to produce gas, and removing at least a portion of the produced gas from the recess through the gas outlet (e.g., 42) of the reactor as a gas stream, where the lid (e.g., 74) is coupled to the reactor body such that the lid covers the recess and the interface between the reactor body and the lid is substantially sealed, where at least a portion of the gas stream includes H₂.

In some embodiments, the photocatalyst is disposed on an interior surface of at least one lid (e.g., 74) and the reactor body (e.g., 14). In some embodiments, the photocatalyst includes an aerogel layer. In some embodiments, the photocatalyst includes a film coating. In some embodiments the photocatalyst is suspended in and/or on the liquid.

In some embodiments the liquid includes water and a sacrificial agent. In some embodiments the contacting includes continuously circulating the liquid through the reactor. Some embodiments include delivering the liquid to the recess (e.g., 26) such that the liquid reaches a desired depth in the recess.

Some embodiments include analyzing a portion of the gas stream (e.g., with gas chromatograph 198) to determine the amount of H₂. Some embodiments include circulating the gas stream through the at least one gas inlet (e.g., 38) and the at least one gas outlet (e.g., 42) until an amount of H₂ reaches a predetermined threshold.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A photocatalytic reactor, comprising:
a reactor body comprising a substantially-planar bottom and one or more sidewalls extending from the bottom to define a recess, the reactor body defining:
at least one liquid inlet,
at least one liquid outlet,
at least one gas inlet that is distinct from the at least one liquid inlet, and
at least one gas outlet that is distinct from the at least one liquid outlet,
wherein each of the inlets and outlets of the reactor body are in fluid communication with the recess; and
a lid configured to be coupled to the reactor body to cover the recess such that the interface between the reactor body and the lid is substantially sealed;
wherein at least one of the reactor body and the lid is configured to transmit incident ultraviolet light into the recess; and
wherein the reactor body is configured to receive a photocatalyst in the recess such that at least a portion of liquid delivered to the recess through the at least one liquid inlet can react with the photocatalyst in the presence of the ultraviolet light to generate gas.

2. The reactor of claim 1, wherein the recess of the reactor body has a maximum height and a maximum transverse dimension that is greater than the maximum height.

3. The reactor of claim 2, wherein the maximum transverse dimension is at least 5 times greater than the maximum height.

4. The reactor of claim 1, wherein the recess is configured such that the liquid is in direct contact with the photocatalyst when the liquid reacts with the photocatalyst in the presence of the ultraviolet light to generate gas.

5. The reactor of claim 1, comprising an aerogel layer disposed on an interior surface of at least one of the lid and the reactor body, wherein the aerogel layer comprises a photocatalyst.

6. A photocatalytic reactor system, comprising:
a reactor of claim 1;
a liquid delivery system comprising a pump, a first conduit configured to be coupled to an outlet of the pump and the at least one liquid inlet of the reactor body, and a second conduit configured to be coupled to an inlet of the pump and the at least one liquid outlet of the reactor body; and
a gas circulation system comprising a pump, a first conduit configured to be coupled to an outlet of the pump and the at least one gas inlet of the reactor body, and a second conduit configured to be coupled to an inlet of the pump and the at least one gas outlet of the reactor body,
wherein at least one of the reactor body and the lid is configured to transmit incident ultraviolet light into the recess, and
wherein the reactor body is configured to receive a photocatalyst in the recess such that reaction of at least a portion of the liquid with the photocatalyst in the presence of the ultraviolet light can generate gas.

7. The system of claim 6, wherein the gas circulation system comprises a valve coupled to at least one of the first and second conduits and configured to selectively interrupt the flow of gas through the at least one of the first and second conduits.

8. The system of claim 6, wherein the recess is configured such that the at least a portion of the liquid directly contacts the photocatalyst when the liquid reacts with the photocatalyst in the presence of the ultraviolet light to generate gas.

9. The system of claim 6, wherein the liquid delivery system is configured to continuously circulate liquid through the recess via the at least one liquid inlet and the at least one liquid outlet or fill a majority of the recess with liquid.

10. The system of claim 6, wherein a photocatalyst is disposed on an interior surface of at least one of the lid and the reactor body, and wherein the photocatalyst comprises an aerogel layer, a film coating, an electroconductive material and a metal oxide, or a combination thereof.

11. (canceled)

12. The system of claim 6, wherein a liquid is disposed in the liquid delivery system and the liquid comprises a reactant and a sacrificial agent.

13. The system of claim 6, wherein the reactor is configured to be positioned at an angle relative to a surface above which the reactor is supported.

15. The system of claim 13, further comprising a stand configured to support the reactor body above a surface in at least a first position in which the reactor body is substantially level, and a second position in which the reactor body is angled relative to the surface.

14. The system of claim 6, further comprising a gasket configured to be disposed between the lid and the one or more sidewalls of the reactor body to seal the interface between the reactor body and the lid.

15. The system of claim 14, wherein at least one of the reactor body and the lid defines a groove configured to receive the gasket, and wherein at least one of the reactor body and the lid comprises one or more polymers, a transparent material, or both.

16. (canceled)

17. The system of claim 6, wherein the recess has a quadrilateral shape, a rectangular shape, or a square shape.

18. The system of claim 6, wherein liquid is disposed in the recess, and a photocatalyst is suspended in and/or on the liquid.

19. The system of claim 6, further comprising: a light source configured to deliver light to the reactor, wherein the light comprises ultraviolet light.

20. A method of producing hydrogen gas (H₂) using a reactor of claim 1, comprising:
delivering a liquid to the recess through the liquid inlet of the reactor body such that the liquid contacts a photocatalyst in the recess in the presence of ultraviolet light to produce gas; and
removing at least a portion of the produced gas from the recess through the gas outlet of the reactor as a gas stream;
wherein the lid is coupled to the reactor body such that the lid covers the recess and the interface between the reactor body and the lid is substantially sealed; and
wherein at least a portion of the gas stream comprises H₂.

21. The reactor of claim 1, wherein the reactor body includes a protrusion extending across the recess such that, when liquid flows through the at least one liquid inlet, the liquid passes over the protrusion before reaching the at least one liquid outlet.

22. The reactor of claim 21, wherein:
the bottom of the reactor body defines a depression; and
the at least one liquid outlet is defined within the depression and/or by a sidewall of the reactor body that is adjacent to the depression.
